(19) United States
(12) Patent Application Publication
(10) Pub. No.: US 2014/0260711 A1
(43) Pub. Date: Sep. 18, 2014

(54) PROBE BALANCER

(71) Applicants: Larry A. Turner, Coal Valley, IL (US); Vincent A. Boens, LeClaire, IA (US)

(72) Inventors: Larry A. Turner, Coal Valley, IL (US); Vincent A. Boens, LeClaire, IA (US)

(21) Appl. No.: 14/204,114

(22) Filed: Mar. 11, 2014

Related U.S. Application Data
(60) Provisional application No. 61/777,418, filed on Mar. 12, 2013.

(51) Int. Cl. G01D 11/30

(52) U.S. Cl. CPC G01D 11/30
USPC 73/866.5

(57) ABSTRACT

A probe balancing device and system is provided for configuring and balancing a probe assembly of a coordinate measurement machine for accurate measurement. It can aid in the correction of an out of balance probe assembly and in meeting a vendor's specified torque and weight specification. A method for configuring and balancing such a probe assembly is also provided. The tool or system may be used either to balance an existing probe assembly or to balance a new probe assembly. Balancing may be accomplished by adding weights to various radial locations of the probe assembly or by changing probe assembly parts and/or component material until a leveling element is centered. A kit may be provided including the tool or system and one or more of a weight scale, a weigh scale stand, one or more weights, or a storage tray for the one or more weights.

### CROSS-REFERENCE TO RELATED APPLICATION

This application claims the benefit of and priority to U.S. Provisional Patent Application No. 61/777,418 entitled “PROBE BALANCER” filed on Mar. 12, 2013, which is incorporated by reference as if fully set forth herein.

### TECHNICAL FIELD

The present disclosure generally relates to a probe balancer and, in particular, a probe balancer for aiding in the correction of coordinate measurement machine probe assemblies.

### BACKGROUND

A coordinate measuring machine (CMM) is a 3D device for measuring the physical geometrical dimensional characteristics of an object. The machine may be manually controlled by an operator or it may be computer controlled. Measurements are performed by a probe attached to a moving axis of the machine. Probes may be mechanical, optical, laser, or white light, amongst others. A machine which takes readings in six degrees of freedom and displays these readings in mathematical form is known as a CMM.

The typical “bridge” CMM is composed of three axes, X, Y and Z axes. These axes are orthogonal to each other in a typical three dimensional coordinate system. Each axis typically has a scale system that indicates locations or positions along that axis. The machine includes a probe and will read the probe location, as directed by the operator or programmer. The machine can use the X, Y, Z coordinates of each input point location to determine size and position with precision.

A CMM can be used in manufacturing, assembly processes, etc. to test a part or assembly against design intent or used to perform precise dimensional inspection evaluations of a product. By precisely recording the X, Y, and Z coordinates of the target by use of the probe points generated can then be analyzed via regression algorithms for the construction of features and to verify design specifications to tolerances.

The probe assembly of a CMM needs to be constructed and configured, in particular balanced and calibrated in order for the machine to take precise measurement. Current devices and techniques for balancing the probe assembly of a coordinate measurement machine, however, are complicated, quite expensive, inadequate, and time consuming.

Accordingly, there is a need to address the aforementioned deficiencies and inadequacies.

### SUMMARY

The present disclosure addresses the aforementioned deficiencies and inadequacies. The present disclosure is directed to a probe balancer device and system for configuring and balancing a probe assembly of a coordinate measurement machine for accurate measurement and a method for configuring and balancing such a probe assembly. It can aid in the correction of an out of balance probe assembly and in meeting a vendor's specified torque and weight specification.

Briefly described, in one aspect, among others, the present disclosure provides a tool, system and/or kit and methods for using them for balancing a probe assembly of a coordinate measurement machine (CMM) that may sit on a work bench or CMM table. The tool may be used either to assist in the balancing of an existing probe assembly or to aid in the balancing of a new probe assembly. Balancing may be accomplished by adding weights to various radial locations of the probe assembly or by changing probe assembly parts and/or component material until the leveling element is centered. A weight scale and a spreadsheet may be provided to calculate an approximate out of balance torque and weight condition. The present system and method can be applied to balancing any probe assembly for use in any coordinate measurement machine.

Other systems, methods, features, and advantages of the present disclosure for a probe balancer for a coordinate measurement machine will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 depicts a conventional coordinate measuring machine (CMM) including probe assemblies for use in conjunction with the coordinate measuring machine.

FIG. 2A depicts an embodiment of our probe balancer including a probe assembly, such as that depicted in FIG. 1, to be balanced for use in connection with a coordinate measuring machine.

FIG. 2B depicts an embodiment of our probe balancing system.

FIG. 2C depicts a close-up view of an exemplary adaptor for connecting a probe assembly of a coordinate measuring machine to the probe balancing system of FIGS. 2A and 2B for balancing the probe assembly.

FIG. 3 is a flow chart depicting an exemplary method of our present disclosure for balancing a probe assembly for a coordinate measuring machine.

FIG. 4 is a chart depicting an example of the method of FIG. 3.

FIG. 5 is a schematic block diagram that provides one example illustration of a computing environment that may be employed according to various embodiments of the present disclosure.

### DETAILED DESCRIPTION

Having summarized various aspects of the present disclosure, reference will now be made in detail to the description of the disclosure as illustrated in the drawings. While the disclosure will be described in connection with these drawings, there is no intent to limit it to the embodiment or embodiments disclosed herein. On the contrary, the intent is to cover all alternatives, modifications and equivalents included within the spirit and scope of the disclosure as defined by the appended claims.

FIG. 1 depicts a conventional coordinate measuring machine (CMM) 100 designed, for example, to record the X, Y, and Z coordinates of a target. There are many different types of coordinate measuring machines. The CMM of FIG. 1 is intended to be representative of all such machines. A coordinate measuring machine typically includes a probe assembly 110 that is used for precisely recording the desired coordinates.

Our probe balancer disclosed herein is designed to provide a straight forward and inexpensive system and method for balancing a probe assembly, such as probe assembly 110, for use in a coordinate measuring machine. Our probe balancer can be provided as a tool, system and/or a kit, for example. FIG. 2A depicts a non-limiting example of one embodiment of our present probe balancer 10 to which a probe assembly, such as probe assembly 110 of FIG. 1, is attached for balancing and after balancing for use in a coordinate measuring machine.

Referring to FIG. 2B, depicted is an embodiment of a probe balancing system and/or kit of our present disclosure. The system and/or kit includes a base 12 and one or more levelers 14 for the base 12. The leveler(s) 14 provide means for leveling the base 12. Mounted to the base is a support 16. In the embodiment depicted, the support 16 is a generally C-shaped frame. One skilled in the art will recognize, however, that other shapes and forms may be used for support 16. At end of the support 16 opposite base 12 is a mount 18 on which a receiver assembly 20 may be mounted. In an aspect the mount 18 may take the form of a holding bar (as depicted in FIGS. 2B and 2C) on which the receiver assembly may be placed and rest.

The receiver assembly 20 can be used to balance or re-balance a probe assembly, in particular a probe assembly 110 for use with a coordinate measuring machine (CMM) such as depicted in FIGS. 1 and 2A. The receiver assembly 20 includes a leveling element 22 that may be for example a round spirit level, though other types of levels may be used. Preferably the level can provide a level reading or feedback in both the x and y directions in a plane substantially perpendicular to the axis of spirit level receiver 20. The receiver assembly 20 may include means for holding the level 22 or to which the level 22 may be secured. Where a round spirit level is included, the receiver assembly 20 may include a recess having an inner dimension that substantially approximates the outer dimension of the level into which the level 22 may be placed. For example, level 22 may be press fit into the recess. In the embodiment shown in FIGS. 2B and 2C level 22 is secured at one end, in particular the top end, of receiver assembly 20.

In the embodiment depicted, receiver assembly 20 includes an opening 24 for mounting on holder 18. In the embodiment depicted mount 18 is a holding bar for receiver assembly 20. Receiver assembly 20 may be vertically suspended by mount 18. Receiver assembly 20 loosely and freely rests on mount 18 such that receiver assembly 20 maintains vertical with respect to gravity, i.e., is plumb with respect to vertical.

At the end of receiver assembly 20 opposite the spirit level 22 is a connector 26 to which an adaptor 28 may be connected. In an embodiment connector 26 is a threaded connector and adaptor 28 may be threaded onto and held by connector 26 of receiver assembly 20. Adaptor 28 serves to attach a probe assembly to the connector 26 of the receiver assembly 20. Connected to adaptor 28 is a device holder 32. As depicted adaptor 28 and device holder 32 may be separate components designed to be connected together. In other aspects the adaptor 28 and the device holder 32 may be a unitary component. As depicted in FIGS. 2A-2C, device holder 32 may be a plate, such as a circular plate, though one skilled in the art would recognize that other configurations may be used. Device holder 32 is designed so that a probe assembly, such as a probe assembly 110, may be removably secured to the device holder 32. In an aspect device holder 32 includes three or more retainers 34 for retaining a mounting plate of a probe assembly to device holder 32. In an aspect, retainers 34 may include three or more posts, each post may include a nylon or other material block designed to be received by the post(s), and a threaded screw, for example a thumb screw or something similar which may be threaded onto or into an end of the post opposite the device holder 32. The three or more retainers are designed to retain and removably secure an upper end of a probe assembly 110 to holder device 32, as depicted in FIG. 2A for example.

Once a probe assembly 110 is secured to device holder 34 and thereby secured to receiver assembly 20, the probe assembly may be balanced by gravity with respect to vertical. To assist in the balancing, the system may be in the form of a kit. In an aspect, the kit may include a scale 42, a scale stand 44, and various weights 46.

With reference to the flowchart of FIG. 3, we now describe an exemplary method 200 of use of our probe balancer system and/or kit 10 for balancing a probe assembly, such as probe assembly 110. A beginning weight reading 210 may be taken of the probe assembly 110 using, for example, scale 42 and scale stand 44. The probe assembly 110, of a coordinate measuring machine (CMM) may be secured 220 to the device holder 32 by way of the three or more retainers 34, as depicted for example in FIG. 2A. As depicted probe assembly 110 may include laterally extending arms 112. When a probe assembly is out of balance, the tip of one of the arms 112 will weigh more than other tip or tips of the probe assembly. The heaviest tip can be weighed (measured) 230. In addition, the distance of the arm having the heaviest tip from its distal tip to the probe center may be measured 240. A torque can be calculated or determined 250 for the arm having the heaviest tip as a product of the weight and length measurements. The calculated torque can be compared to a torque specified for the probe assembly. The comparison of the calculated torque to the probe assembly specified torque can be used to adjust the weighting of the arms 112 to achieve a level reading as displayed by level 22. To achieve the balancing 260, one or more weights may be added to, or removed from, one or more of the arms 112. Probe assembly parts may also be changed to achieve the balancing. Once the probe assembly has been balanced, it may then be detached (removed) 270 from the device holder 32 and re-attached to its coordinate measuring machine 100.

FIG. 4 is a chart depicting a non-limiting example for carrying out the method in FIG. 3. As seen in FIG. 4, a probe head reference number is selected 205 for referencing probe head specifications entered by the user. It is then weighed 210 to provide a measured starting probe assembly weight. As depicted in the chart of FIG. 4 the starting weight is 400 gm and is 67% of the specified weight for the probe assembly. The probe assembly is then secured 220 to our probe balancer, and we weigh 230 the heaviest arm or tip of the probe assembly. As depicted in FIG. 4, the measured weight of the heaviest tip is 60 gm. We then measure 240 the distance from the probe center to the heaviest arm or tip. In the present example, this distance is 300 mm. An estimated torque is determined 250 based upon the weight and distance measurements, which in the present example results in a value of 12.0 gm. This torque is compared to the torque specified for the particular probe assembly and determined to be 118% of the specified torque. The maximum specified torque is converted to a value in grams, in this case 10.2 gm. We then add counterweights to the light side, or alternatively we can remove weight from the heavy side, to balance the probe 260. Once the probe assembly has been balanced, it is removed or detached from our probe balancing system for attachment to its coordinate measuring machine.

We now describe an embodiment of a system for carrying out one or more aspects of our method of balancing a probe assembly using, for example our probe balancing system and/or kit, such as those described above. In one or more embodiments our present method may be carried out by programming logic executed in a computing environment. With reference to FIG. 5, shown is a schematic block diagram of a system including a computing environment 101 according to an embodiment of the present disclosure. The computing environment 101 may include one or more computing devices 401. Each computing device 401 may include at least one processor circuit, for example, having a processor 402, a memory 404, a user interface 406, and an input/output (I/O) device 408, which may be coupled to a local interface 407. To this end, each computing device 401 may comprise, for example, at least one server computer or like device. The local interface 407 may comprise, for example, a data bus with an accompanying address/control bus or other bus structure as can be appreciated. The computing environment 101 may comprise, for example, a hand-held device, a portable device, a computer, server, dedicated processing system, or other system, as can be appreciated. The hand-held device can be, for example, a smart mobile phone or a tablet.

The computing environment 101 of such device may include various input devices such as a keyboard, microphone, mouse, touch screen, or other device, as can be appreciated. By way of example, the system can comprise a stand-alone device or part of a network, such as a local area network (LAN), GPRS cellular network or wide area network (WAN).

The processor 402 may include a central processing unit (CPU) or a semiconductor-based microprocessor in the form of a microchip. In addition, the processor 402 may represent multiple processors and the memory 404 may represent multiple memories that operate in parallel. In such a case, the local interface 407 may be an appropriate network that facilitates communication between any two of the multiple processors, between any processor and any one of the memories, or between any two of the memories, etc. The processor 402 may be of electrical or optical construction, or of some other construction as can be appreciated by those with ordinary skill in the art.

Stored in the memory 404 are both data and several components that are executable by the processor 402. In particular, stored in the memory 404 and executable by the processor 402 may be programming logic 110, and potentially other applications. Also stored in the memory 404 may be a data store 111 storing for example general data concerning reference numbers, weight readings or values acquired for a starting probe assembly, weight readings or values acquired during balancing of a probe assembly, and other data. In addition, an operating system may be stored in the memory 404 and executable by the processor 402.

It is understood that there may be other applications that are stored in the memory 404 and are executable by the processor 402 as can be appreciated such as an operating system. Where any component discussed herein is implemented in the form of software, any one or more of a number of programming languages may be employed such as, for example, C, C++, C#, Objective C, Java®, JavaScript®, Perl, PHP, Visual Basic®, Python®, Ruby, Flash®, or other programming languages.

A number of software components may be included in the programming logic 110 and may be stored in the memory 404 and executable by the processor 402. In this respect, the term “executable” means a program file that is in a form that can ultimately be run by the processor 402. Examples of executable programs may be, for example, a compiled program that can be translated into machine code in a format that can be loaded into a random access portion of the memory 404 and run by the processor 402, source code that may be expressed in proper format such as object code that is capable of being loaded into a random access portion of the memory 404 and executed by the processor 402, or source code that may be interpreted by another executable program to generate instructions in a random access portion of the memory 404 to be executed by the processor 402, etc. An executable program may be stored in any portion or component of the memory 404 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The operating system may control the execution of these programs as well as other programs and provides scheduling, input-output control, file and data management, memory management, and communication control and related services. The operating system may be executed to control the allocation and usage of hardware resources such as the memory, processing time and peripheral devices in the computing environment 101. In this manner, the operating system may serve as the foundation on which applications depend as is generally known by those with ordinary skill in the art.

The memory 404 is defined herein as including both volatile and nonvolatile memory and data storage components. Volatile components are those that do not retain data values upon loss of power. Nonvolatile components are those that retain data upon a loss of power. Thus, the memory 404 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 402 may represent multiple processors 402 and/or multiple processor cores and the memory 404 may represent multiple memories 404 that operate in parallel processing circuits, respectively. In such a case, the local interface 407 may be an appropriate network that facilitates communication between any two of the multiple processors 402, between any processor 402 and any of the memories 404, or between any two of the memories 404, etc. The local interface 407 may comprise additional systems designed to coordinate this communication, including, for example, performing load balancing. The processor 402 may be of electrical or of some other available construction.

The user interface 406 may comprise the components with which a user interacts with the processing circuit and therefore may comprise, for example, a keyboard, mouse, and a display, such as a liquid crystal display (LCD) monitor. The user interface 406 can also comprise, for example, a touch screen that serves both input and output functions. The user interface may provide any number of interfaces for the input and output of data. The one or more I/O devices 408 are adapted to facilitate communications with other devices or systems and may include one or more communication components such as a modulator/demodulator (e.g., modem), wireless (e.g., radio frequency (RF)) transceiver, network card, etc.

Our system and method may take into account that each individual probe assembly may be different and may require balancing differently to other probe assemblies. In an aspect the system may configured to acquire data concerning the probe assembly to be balanced. For example, the system may include weight scale 42 to weight a probe assembly and acquire a weight value for a probe assembly in accordance with, for example, steps 210 and 230 of FIG. 3. The weigh scale can be designed to communicate with a computing environment 101 or processor circuit, providing the measured weight data to the computing environment 101. The computing environment can include programming logic 110 for receiving or acquiring measured weight data.

A smart device, such as a smart phone or tablet, may include a processor circuit on which the programming logic 110 can be executed. For example, the programming logic may take the form of an app that can be downloaded onto the smart device and executed by the processing system. One or more of weight readings may be entered using an input device for the smart device and result(s) or recommendation(s) from one or more of the steps of for example, FIG. 3 may be output on the smart device.

As described herein, the processor circuit, in particular the software provided on the processor circuit, may be configured to receive weight data or values acquired by the weigh scale 42 and evaluate the acquired data to determine, for example, a starting weight reading or value for the probe assembly, as well as subsequent weight readings or values acquired during the balancing process.

Although the programming logic 110, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowchart of FIG. 3 shows the functionality and operation of an implementation of portions of the programming logic. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 402 in a computer system or other system. The machine code may be converted from the source code, etc. If embodied in hardware, each block may represent a circuit or a number of interconnected circuits to implement the specified logical function(s).

Although the flowchart of FIG. 3 shows a specific order of execution, it is understood that the order of execution may differ from that which is depicted. For example, the order of execution of two or more blocks may be scrambled relative to the order shown. Also, two or more blocks shown in succession in FIG. 3 may be executed concurrently or with partial concurrence. Further, in some embodiments, one or more of the blocks shown in FIG. 4 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the programming logic 110, that comprises software or code can be embodied in any non-transitory computer-readable medium for use by or in connection with an instruction execution system such as, for example, a processor 402 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed:

1. A method of balancing a probe assembly comprising the steps of:
a) providing a probe receiver assembly, the probe receiver assembly including a level;
b) freely suspending the probe receiver assembly with respect to gravity;
c) obtaining a starting weight for the probe assembly;
d) securing the probe assembly to the probe receiver assembly;
e) determining a heaviest arm or tip of the probe assembly and weighing the heaviest arm or tip of probe assembly on the receiver assembly;
f) measuring a distance from the center point of the probe assembly to a distal end of the heaviest arm or tip of the probe assembly;
g) determining a torque value for the heaviest arm or tip of the probe assembly as a function of the measured weight and distance of the heaviest arm or tip; and
h) balancing the probe assembly based on the determined torque by adding and/or removing weight(s) to the probe assembly.

2. The method of claim 1, further including the step of removing the probe assembly from probe receiver assembly and attaching the probe assembly to a coordinate measuring machine.

3. The method of claim 1, wherein the probe receiver assembly is a component in a probe balancing system that is provided, the probe balancing system including a base, one or more levelers for the base, and a support for the probe receiver assembly mounted on the base, the support including a mount on which the probe receiver assembly is freely suspended with respect to gravity.

4. The method of claim 1, wherein the probe receiver assembly is freely suspended to maintain a vertical position with respect to gravity.

5. The method of claim 1, wherein the level provides a level reading in both the X and Y directions in a plane substantially perpendicular to a vertical axis of the probe receiver assembly.

6. A system for balancing a probe assembly, the system comprising a base, one or more levelers for the base, a probe receiver assembly including a level, a support for the probe receiver assembly mounted on the base, the support including a mount on which the probe receiver assembly is freely suspended with respect to gravity, and an adaptor designed to attach a probe assembly to the probe receiver assembly.

7. The system of claim 6, wherein the probe receiver assembly is freely suspended by the mount to maintain a vertical position with respect to gravity.

8. The method of claim 6, wherein the level provides a level reading in both the X and Y directions in a plane substantially perpendicular to a vertical axis of the probe receiver assembly.

9. The system of claim 6, wherein the adaptor includes a removable device holder to which a probe assembly may be detachably secured.

10. The system of claim 9, wherein the device holder includes three or more retainers for removably securing a mounting plate of a probe assembly to the device holder.

11. The system of claim 6, wherein the adaptor includes a device holder to which a probe assembly may be detachably secured, the adaptor and the device holder comprising a unitary element.

12. A kit for balancing a probe assembly, the kit comprising the system of claim 6, a scale for weighing a probe assembly, and one or more weights designed to be attached to the probe assembly.

13. The kit of claim 12, further including a stand for the weigh scale.

14. The kit of claim 12, further including a tray for storing the one or more weights.
